(19) United States
(12) Patent Application Publication
(10) Pub. No.: US 2013/0295249 A1
(43) Pub. Date: Nov. 7, 2013

(54) GRANULATED FOOD PRODUCT

(71) Applicants: Rebecca Hwee Peng Lian, Beijing (CN); Dong Shen, Shanghai (CN); Helge Ulmer, Singapore (SG); Chang Liu, Beijing (CN)

(72) Inventors: Rebecca Hwee Peng Lian, Beijing (CN); Dong Shen, Shanghai (CN); Helge Ulmer, Singapore (SG); Chang Liu, Beijing (CN)

(73) Assignee: NESTEC S.A., Vevey (CH)

(21) Appl. No.: 13/822,086

(22) PCT Filed: Sep. 8, 2011
(86) PCT No.: PCT/EP11/65557

§ 371 Date: Mar. 11, 2013

(30) Foreign Application Priority Data
Sep. 10, 2010 (CN) 201010290090.4

(51) Int. Cl. A23L 1/223; A23L 2/08; A23L 1/40

(52) U.S. Cl. CPC A23L 1/223; A23L 1/40; A23L 2/08
USPC 426/285; 426/650; 426/589; 426/590

(57) ABSTRACT

A granulated food product comprising plant material from one or more aromatic plants, a meaty base and an osmotic agent, and a method for preparing a granulated food product comprising milling plant material from one or more aromatic plants together with a meaty base, mixing the milled material with an osmotic agent to form a viscous mixture, granulating the viscous mixture, and drying the granules.

### TECHNICAL FIELD

This invention relates to a granulated food product comprising plant material from aromatic plants, a meaty base and an osmotic agent, which exhibits authentic flavours and aromas of the fresh plant and a dense meaty flavour at the same time. The invention also relates to a method of preparing the granulated product.

### BACKGROUND

Aromatic plants and herbs have been valued for their aroma and flavour in food preparations for centuries. Since fresh herbs are seasonal and have a short shelf-life, they have been preserved by many methods. The most common methods of preservation have generally involved the removal of moisture (drying) or the concentration of herb solids in order to reduce the possibility of microbial growth and spoilage. Other known methods for herb preservation involve salting or soaking in a brine solution. Drying may be achieved through various methods, including solar and oven dehydration. Attempts to reduce the loss of volatile herb flavours, aromas and colour during dehydration have involved alternative, more expensive, drying methods such as freeze drying and vacuum drying.

However, all these dehydration methods result in the deterioration of the quality of the fresh herbs. In particular, the colour, flavour, aroma and overall appearance of the herb are significantly impaired. Furthermore, it has long been recognized that dehydrated herbs undergo oxidation during storage resulting in further discolouration (browning) and further loss or undesirable alteration of flavour, colour and aroma. Oxidation of dehydrated herbs during storage can be inhibited to a degree by the use of chemical anti-oxidants. However, the addition of such chemicals is generally undesirable and may also give the food an unwanted chemical taste. Dehydration using hot air or by pickling destroys the fresh appearance of herbs, particularly colour due to cellular damage and enzymatic browning. This can be explained in part by decomposition of chlorophyll. Preservation by air drying at elevated temperatures also causes the loss of many of the volatile flavour components as well as the generation of off-flavours such as fish, hay and tea notes.

U.S. Pat. No. 5,227,183 is directed to preserving the flavour and aroma of aromatic plants while extending their useful shelf-life in products. A process is described where fresh plants are blanched with a humectant solution at a temperature not less than 180° C. Blanching helps to deactivate enzymes so that the enzymatic action is prevented and flavour compounds do not decompose. However, a flavour that is generated without any enzymatic action exhibits a “dried” flavour, which is less desirable than the authentic fresh flavours released by freshly cut plants. Although the products described in this patent maintain a long shelf-life by deactivation of enzymes during the preparation process, they fail to provide flavours as fresh as those released by the fresh plants.

U.S. Pat. No. 5,227,183 also describes the use of osmotic agents for forming an amorphous film over the plant tissue and, in particular, over the oil sacs or glands of herbs.

The film is able to prevent the compounds in the sacs and glands from escaping into the surrounding atmosphere. The film may also limit the exposure of compounds to oxygen to reduce undesirable flavours caused by lipid oxidation. The use of osmotic agents enables aromatic plants to retain their colour, flavours and aromas for a long time. However, the blanching used in the process adversely affects the aroma and/or flavor of the plant material, and full freshness of the plant cannot be delivered.

Meat tasting seasonings are commonly used in culinary products to provide a meaty flavour and nutritional protein material. The meaty seasoning is usually prepared by extraction from, or dehydration of, bones or meat of animals, poultry or seafood. For example, a publication by HUANG Hong-wei and QIU Yan-xiang (Food Science and Technology No. 9. 2005, 91-93) discloses an ultrafine fresh bone powder of animals including the steps of ultrafine grinding, enzyme digestion, Maillard reaction and emulsification. In another example, Chinese patent application 200710195750.9 discloses a spicy meaty seasoning prepared by frying dried chilli and zanthoxylum and then mixing them with a meat extract.

However, there is no known single product or process that provides complex plant flavours or aromas combined with meaty flavours. Such a product would go a long way to satisfying customer needs for flavour combinations appropriate for many culinary preparations in a convenient and efficient food format.

It is therefore an object of the invention to provide a granulated food product that at least goes part way to overcoming one or more of the above disadvantages of existing products, or at least provides a useful alternative.

### SUMMARY OF THE INVENTION

In a first aspect of the invention there is provided a granulated food product comprising plant material from one or more aromatic plants, a meaty base and an osmotic agent, wherein the total content of the plant material and the meaty base in the product is from 0.2 to 48% by weight of dry matter, and wherein the product is in a granulated form with the average size of granules in the range 0.5 mm to 5.0 mm.

The total content of the plant material and the meaty base in the product is preferably from 0.25 to 30%, more preferably 0.25 to 5%, by weight of dry matter. Preferably the average size of the granules is in the range 1.2 mm to 3.5 mm.

The plant material and the meaty base may be present in the product in a weight ratio of plant material to meaty base in the range 1:400 to 400:1, preferably 1:150 to 150:1 or 1:50 to 50:1 or 1:20 to 20:1, by weight dry matter.

The plant material may be in the form of whole vegetables or fruits, or pieces of vegetables or fruits, or an extract of vegetables or fruits. Preferably the vegetables are carrots, broccoli, cauliflower, asparagus, pumpkin, corn, leek, red beet, tomatoes, celery, ginger, or mushrooms. The fruits may preferably be mangoes, oranges, papaya, bananas, lemons, limes, pineapples, apples, and pears.

Preferably the meaty base contains meat extract and/or meat hydrolysates, cysteine and reducing sugars. The meat extract is preferably obtained from chicken, beef, seafood, mutton, pork, or animal bone.

The osmotic agent may be any suitable agent but is preferably starch, maltodextrin, gum, wheat flour, rice flour, non-dairy creamer, or sugars such as maltose, sucrose, fructose, syrups, or lactose.

It is preferred that the product of the invention has a moisture content of not more than 10%.

In a second aspect of the invention there is provided a granulated food product, comprising the steps:
a) milling plant material from one or more aromatic plants together with a meaty base;
b) mixing the milled material obtained from step a) with an osmotic agent at a temperature of −10 to 65° C. to form a viscous mixture having a moisture content of up to 30% by weight;
c) granulating the viscous mixture to obtain granules; and
d) drying the granules to reduce the moisture content to 0.5 to 10% by weight.

The meaty base is preferably obtained by hydrolyzing meat protein using proteolysis, blending with reducing sugars, and heating for 10 to 120 minutes at a temperature of 55 to 120° C.

It is also preferred that the granulation may be performed by high shear granulation, fluidized bed granulation, extrusion-spheronization granulation, spray drying granulation, tablet compression, or roller compaction.

The invention also provides a composition which is a savoury, seasoning, bouillon, sauce or gravy comprising the granulated food product of the invention, and a finished or intermediate food or beverage product prepared using the granulated food product of the invention.

### DETAILED DESCRIPTION

The granulated food product of the invention comprises plant material from aromatic plants, a meaty base and an osmotic agent. The product is generally used as a flavouring or seasoning agent in the preparation of foods or beverages for consumption. The product exhibits authentic aromas and flavours of fresh plant and a dense meaty flavour at the same time. In addition to being nutritionally rich, consumer demands are also met by providing the product in granulated form which will, upon rehydration, readily dissolve and exhibit authentic, natural, fresh aroma and colour characteristics, together with a rich meat flavour. Granulation of the product can also extend the shelf-life of the product. The invention also provides a method for preparing the granulated food product.

The term “aromatic plant” is used to denote those plants having specialized tissues which contain aromatic components possessing strong flavour and aroma, and include herbs such as celery, mushroom, coriander, basil, parsley, ginger and the like, many of which are characterized by oil sacs or glands which contain the flavour and aroma values of the plant. Aromatic plants usually contain vacuoles filled with enzymes which, on rupture of the plant cells, transform precursors into flavour and aroma compounds typical of freshly cut aromatic plants. Aromatic plants such as herbs are prized primarily for their colour, flavour and aroma. Preferred aromatic plants include vegetables such as carrots, broccoli, cauliflower, asparagus, pumpkin, corn, leek, red beet, tomatoes, celery, ginger and mushrooms, and fruits such as mangoes, oranges, papaya, bananas, lemons, limes, pineapples, apples, and pears.

The term “meaty base” refers to seasonings that have a rich meat flavour. The meaty bases used in the present invention preferably contain meat extracts and meat hydrolysates, and also cysteine and reducing sugars. The meat extracts may be prepared from chicken, beef, seafood, mutton, or pork, as well as animal bone. The reducing sugars are those having chemical reducing properties and are preferably ribose, xylose, glucose, fructose or mixtures thereof.

The term “osmotic agent” refers to a compound that can create an osmotic pressure sufficient to cause moisture to migrate from the plant cell to the outside and lead to the product of the invention having a high viscosity. The osmotic agent may be dried to form a non-crystalline or amorphous coating over the plant tissue and, in particular, over oil sacs, glands and vacuoles of the plant tissue. The osmotic agents used in the invention are those commonly used in food industry, and are preferably starch, maltodextrin, gum, wheat flour, rice flour, non-dairy creamer, sugars or mixtures thereof.

The granulated food product of the invention comprises from 0.2 to 48% by weight of dry matter of plant material from one or more aromatic plants and meaty bases. The remainder is osmotic agents. The preferred range is from 0.25 to 30%, and a more preferred range is from 0.25 to 5%.

The weight ratio of plant material and meaty bases preferably ranges from 1:400 to 400:1. When the weight ratio is less than 1:400, the aromatic flavour of the granulated food product tends to be low. On the contrary, when the weight ratio is more than 400:1, the meat flavour tends to be low. The weight ratio of plant material and meaty base preferably ranges from 1:150 to 150:1, more preferably from 1:50 to 50:1, and most preferably from 1:20 to 20:1.

The final product should have a moisture content of not more than 10%. In a particularly preferred embodiment, the product has a moisture content of from about 2% to 5%. It has been found that at water content of about 5% or less the encapsulation can be formed well.

The purpose of the osmotic agent is to encapsulate the plant material and meaty base. The term “encapsulate” means that the osmotic agent forms an amorphous coating that substantially covers the oil sacs, glands and vacuoles of the plant material. It is impossible to encapsulate all tissues, oil sacs and glands due to the damage caused to the plant material during the process for preparing the granules. However, if enough plant tissue, oil sacs and glands are encapsulated, the more unwanted enzymes (especially peroxidises) will be held within the tissue, oil sacs and glands and unable to cause undesirable degradation of the plant material and meaty base. It is therefore preferred that the encapsulation be as complete as possible for the product to compare favourably with fresh aromatic plant.

Peroxidases are hydrogen peroxide-reducing enzymes, occurring in animal and plant tissues in large numbers and with high activity. They catalyze the dehydrogenation (oxidation) of various substances in the presence of hydrogen peroxide. Polyphenol oxidase is another enzyme present in animal and plant tissues. This enzyme catalyses the oxidation of various phenolic compounds. Therefore, the more the activity of peroxidases and polyphenol oxidases is retained in the plant material, the more overall freshness of aroma and flavour is achieved, similar to when the aromatic plant is freshly cut.

In the granulated food product of the invention, oxidase enzymes are not inactivated, but are solidified within the plant, resulting in a much more authentic freshness than conventional products where enzymes are inactivated, for example by blanching. When the granulated product of the invention is rehydrated with water, the true aroma and flavour returns due to the transformation of flavouring compounds within the plant cells.

The product of the invention is in granulated form, where the average granule size is 0.5 mm to 5.0 mm in either length or diameter. If the granule size is more than 5.0 mm in length or diameter, the granule becomes brittle and easily broken or crumbled during transportation and/or storage. Additionally, granules that are two large need more time to dissolve in water. On the other hand, the granules should not be too small, preferably having a length or diameter not less than 0.5 mm. Granules that are too small tend to conglomerate in water and are hard to fully dissolve in water even with stirring. In addition, fine granules have strong hygroscopicity. Thus, a powdery product will absorb moisture from the air and become hydrated, resulting in deterioration of the product and a shorter shelf-life. Preferably, the granules of the invention have an average size of 1.2 mm to 3.5 mm in either length or diameter. Although not critical, a product having a uniform granule size is preferred, for optimum dissolvability and flowability.

Another aspect of the invention relates to a method for preparing the granulated food product described above, comprising steps of:
a) milling plant material from one or more aromatic plants together with a meaty base;
b) mixing the milled material obtained from step a) with an osmotic agent at a temperature of −10 to 65° C. to form a viscous mixture having a moisture content of up to 30% by weight;
c) granulating the viscous mixture to obtain granules; and
d) drying the granules to reduce the moisture content to 0.5 to 10% by weight.

Fresh aromatic plants are harvested and preferably kept cool prior to processing to prevent enzymatic degradation. Before subjecting the plant material to the milling step, washing and surface disinfecting the plant is preferred. This removes dirt, debris and other organic matter which can increase the microbial content of the herb. Such washing may comprise spraying the plants with, or immersing them in, water, a water-detergent, or water-wetting agent mixture. If detergent or other wetting agent is used, the plants should be rinsed to remove any residual detergent/wetting agent. Excess water from the washing step should also be removed. The surface disinfection may also be carried out independently after washing step.

The freshly harvested plants may be pre-treated by separating the leaves from the stems, depending on the specific plant treated. The fresh plant may be further sliced into small pieces in preparation for milling. This separating and/or slicing process may be accomplished by any suitable manner known to those skilled in the art.

The meaty base may be prepared based on the Maillard reaction. In particular, the method for preparing the meaty bases comprises the steps: cleaning and cutting or pulverising fresh meat, adding protease to the fresh meat in amount of 0.1-0.5 wt % of the fresh meat, heating the meat to 45-55° C. and for 30 to 90 minutes to enable enzymatic hydrolysis, deactivating the protease by heating to 80-90° C. for 2-5 minutes, cooling and filtering to obtain a filtrate, adding reducing sugar to the filtrate in the same amount as the fresh meat, and reacting for 10-120 minutes at temperature of 55-120° C.

The washed and sliced fresh aromatic plant and the meaty base are then milled. Any acceptable milling/grinding method known in the food industry can be used. Since the plants are fresh and contain considerable moisture, it is preferred to use wet milling or colloid milling. A colloid mill can reduce the particle size of a solid in suspension in a liquid, by applying hydraulic shear to the processed liquid. Excessive milling time and/or shearing are to be avoided to limit rupture of the plant cells.

Mixing of milled aromatic plant and meaty base with an osmotic agent can be achieved using any type of mixer known in the art. The osmotic agent used must be able to dehydrate the plant material being treated and create a high osmotic pressure. The preferred agents are starch, maltodextrin, gum, wheat flour, rice flour, non-dairy creamer, sugars and mixtures thereof. To some degree the choice of the osmotic agent depends on its cost and commercial availability. In addition, the osmotic agents are usually fine powders so that the fresh plant and meaty base can be completely covered.

The duration of mixing should be sufficient to obtain a uniformly dispersed mixture, and is preferably 0.1 to 60 minutes. The mixture obtained is a viscous material, which is then subjected to the granulation process.

The granulation method may any one selected from sifting, high shear granulation, fluidized bed granulation, extrusion-spheronization granulation, spray drying granulation, tablet compression, and roller compaction. The granulation process generates granules having a length or diameter of between 0.5 to 5 mm. As mentioned above, granules that are too large or too small are problematic.

The processes described above may be carried out at ambient temperatures. In preferred embodiments of the invention, the temperature for milling, mixing and granulating is in the range from −10 to 65° C., preferably from −5 to 60° C., more preferably −5 to 20° C. At high temperatures, the enzymes will deteriorate. Relatively low temperatures help to solidify the enzymes, which are then unable to degrade the flavour compounds in the plants.

The drying conditions are not critical, but must enable the water content in the finished product to be reduced, so that an amorphous film encapsulating the oil sacs or glands of the plants can be formed. The drying temperature can vary within a suitable range. For example, if the drying temperature is relatively high, the drying duration should be relatively short so that the temperature inside the granules will not deactivate the enzymes. It has been found that at water content of about 5% or less, amorphous films are formed. Excessive drying below about 0.5% may be detrimental to flavour and cause texture degradation. Conventional drying techniques including air drying, air convection drying, fluidized bed drying, vacuum drying, freeze drying, solar drying and the like.

Although the process can be carried out in batch form, it is preferred that the process be continuous so that, as is customary in production facilities, speed throughput speed is maximised. In handling of freshly harvested plants, it will be appreciated that for different plants, different specific treatment parameters for each step of the process may be required.

Microscopic and flavour profile examinations of the finished product confirm that the product retains its characteristic fresh colour and flavour. Upon rehydration, colour, flavour, aroma, and overall appearance are very similar to freshly cut aromatic plants. Sensory evaluation descriptive panels indicate that the product prepared in the above manner has both an aromatic flavour of fresh plants and a rich meat flavour.

This product can also be suitable for other food applications where fresh colour and flavour are desirable. That is, the granulated food product of the invention can be used for preparing savoury or seasoning or bouillon compositions, and finished or intermediate food or beverage products.

As used in this specification, the words “comprises”, “comprising”, and similar words, are not to be interpreted in an exclusive or exhaustive sense. In other words, they are intended to mean “including, but not limited to”.

Further, any reference in this specification to prior art documents is not intended to be an admission that they are widely known or form part of the common general knowledge in the field.

### EXAMPLES

The invention is further described with reference to the following examples. It will be appreciated that the invention as claimed is not intended to be limited in any way by these examples.

### Example 1

### The Preparation of Meaty Bases

Cleaned fresh meat (e.g. beef, chicken or pork) was crushed and a protease added to the fresh meat in amount of 0.2 wt % of meat. The meat was heated with the protease at 50° C. for 60 minutes for enzymatic hydrolysis to occur. The mixture was then heated to 90° C. for 5 minutes to deactivate the protease. After cooling and filtering, the filtrate obtained was mixed with fructose in the same amount as the fresh meat, and maintained at 80° C. for 10 to 120 minutes.

### Example 2

De-rooted fresh leek (9 kg) and beef meaty base (0.01 kg) were mixed and milled, and subsequently mixed with starch (90 kg) and maltodextrin (65 kg) for 1 min at 5° C. The mixture was then granulated to a granule size of 2 mm, and dried using a fluidized bed for 0.5 min with air at 105° C. The final product had a moisture content of 4.5%. The total amount of leek and meaty base was 5.5% of wet ingredient which corresponded to 0.25 w/w % of dry matter of the total final product. The finished product was strong in leek aroma and taste, and beef flavour. Upon rehydration, the product exhibited the appearance of freshly cut leek.

### Example 3

Washed fresh pineapple (18 kg) and pork meaty base (0.5 kg) were mixed and milled, and subsequently mixed with starch (100 kg) and maltose (40 kg) for 1 min at −2° C. The mixture was granulated to a granule size of 1.0 mm, and dried using a fluidized bed for 1 min with air at 110° C. The final product had a moisture content of 1.5%. The total amount of pineapple and meaty base was 11.6% of wet ingredient which corresponded to 1.5 w/w % of dry matter of the total final product. The finished product was strong in pineapple aroma and taste, and pork flavour. Upon rehydration, the product exhibited the appearance of fresh pineapple.

### Example 4

Fresh mushroom (9 kg) and chicken meaty base (3 kg) were mixed and milled, and subsequently mixed with starch (75 kg) and maltodextrin (70 kg) for 2 min at 10° C. The mixture was then granulated to a granule size of 3 mm, and dried using a fluidized bed for 3 min with air at 65° C. The final product had a moisture content of 2.5%. The total amount of mushroom and meaty base was 3.9% of wet ingredient which corresponded to 2.2 w/w % of dry matter of the total final product. The finished product had an intensive mushroom aroma and had a chicken flavour. After rehydrated, the product exhibited the appearance of fresh mushroom.

### Example 5

Fresh carrot (0.5 kg), fresh tomato (0.5 kg) and beef meaty base (8 kg) were mixed and milled, and subsequently mixed with starch (90 kg) and maltodextrin (65 kg) for 3 min at 20° C. The mixture was then granulated to a granule size of 4 mm, and dried using a fluidized bed for 60 sec using air at 105° C. The final product had a moisture content of 2.5%. The total amount of carrot, tomato and meaty base was 5.5% of wet ingredient in the recipe which corresponded to 4.8 w/w % of dry matter of the total final product. The finished product had intensive carrot and tomato aromas, and had beef flavor. Upon rehydration, the product exhibited the appearance of carrot and tomato.

### Example 6

Fresh apple (0.1 kg), fresh carrot (0.1kg) and beef meaty base (12 kg) were mixed and milled, and subsequently mixed with starch (50 kg) and wheat flour (50 kg) for 20 sec at 10° C. The mixture was then granulated to a granule size of 4 mm, and dried using a fluidized bed for 1.5 min using recirculating air at 50° C. The final product had a moisture content of 2.5%. The total amount of apple, carrot and meaty base was 11.4% of wet ingredient in the recipe which corresponded to 10.2 w/w % of dry matter of the total final product. The finished product has intensive apple and carrot aromas, and had a beef flavor. Upon rehydration, the product exhibited the appearance of fresh apple and carrot.

It is to be appreciated that although the invention has been described with reference to specific embodiments, variations and modifications may be made without departing from the scope of the invention as defined in the claims. Furthermore, where known equivalents exist to specific features, such equivalents are incorporated as if specifically referred to in this specification.

1. A granulated food product comprising plant material from one or more aromatic plants, a meaty base and an osmotic agent, the total content of the plant material and the meaty base in the product is from 0.2 to 48% by weight of dry matter, and the product is in a granulated form with the average size of granules is 0.5 mm to 5.0 mm.

2. A product as claimed in claim 1, wherein the total content of the plant material and the meaty base in the product is from 0.25 to 30%, by weight of dry matter.

3. A product as claimed in claim 1, wherein the average size of the granules is 1.2 mm to 3.5 mm.

4. A product as claimed in claim 1, wherein the plant material and the meaty base are present in the product in a weight ratio of plant material to meaty base is 1:400 to 400:1.

5. A product as claimed in claim 1, wherein the plant material is selected from the group consisting of whole vegetables, whole fruits, pieces of vegetables, pieces of fruits, an extract of vegetables, and an extract of fruits.

6. A product as claimed in claim 5, wherein the vegetables is selected from the group consisting of carrots, broccoli, cauliflower, asparagus, pumpkin, corn, leek, red beet, tomatoes, celery, ginger, and mushrooms.

7. A product as claimed in claim 5, wherein the fruits is selected from the group consisting of mangoes, oranges, papaya, bananas, lemons, limes, pineapples, apples, and pears.

8. A product as claimed in claim 1, wherein the meaty base contains meat extract and/or meat hydrolysates, cysteine and reducing sugars.

9. A product as claimed in claim 8, wherein the meat extract is selected from the group consisting of chicken, beef, seafood, mutton, pork, and animal bone.

10. A product as claimed in claim 1, wherein the osmotic agent is selected from the group consisting of starch, maltodextrin, gum, wheat flour, rice flour, non-dairy creamer, and sugars such as maltose, sucrose, fructose, syrups, and lactose.

11. A product as claimed in claim 1, which product has a moisture content of not more than 10%.

12. A method for preparing a granulated food product comprising the steps:
milling plant material from one or more aromatic plants together with a meaty base;
mixing the milled material with an osmotic agent at a temperature of −10 to 65° C. to form a viscous mixture having a moisture content of up to 30% by weight;
granulating the viscous mixture to obtain granules; and
drying the granules to reduce the moisture content to 0.5 to 10% by weight.

13. A method as claimed in claim 12, wherein the meaty base is obtained by hydrolyzing meat protein using proteolysis, blending with reducing sugars, and heating for 10 to 120 minutes at a temperature of 55 to 120° C.

14. A method as claimed in claim 12, wherein the granulation may be performed a step selected from the group consisting of high shear granulation, fluidized bed granulation, extrusion-spheronization granulation, spray drying granulation, tablet compression, and roller compaction.

15. A composition which is a savoury, seasoning, bouillon, sauce or gravy comprising a granulated food product comprising plant material from one or more aromatic plants, a meaty base and an osmotic agent, the total content of the plant material and the meaty base in the product is from 0.2 to 48% by weight of dry matter, and the product is in a granulated form with the average size of granules is 0.5 mm to 5.0 mm.

16. A finished or intermediate food or beverage product prepared using a granulated food product comprising plant material from one or more aromatic plants, a meaty base and an osmotic agent, the total content of the plant material and the meaty base in the product is from 0.2 to 48% by weight of dry matter, and the product is in a granulated form with the average size of granules is 0.5 mm to 5.0 mm.
